(19) United States
(12) Patent Application Publication
(10) Pub. No.: US 2005/0222621 A1
(43) Pub. Date: Oct. 6, 2005

(54) Teething mitten for an infant

(76) Inventors: Donald Lloyd Duwelius, Naperville, IL (US); Carrie Jeanne Duwelius, Naperville, IL (US)

Correspondence Address: Donald Lloyd Duwelius, 330 Carriage Hill Rd., Naperville, IL, 60565, US

(21) Appl. No.: 11/090,503

(22) Filed: Mar. 25, 2005

Related U.S. Application Data
(60) Provisional application No. 60/558,041, filed on Mar. 31, 2004.

(51) Int. Cl. A61J 17/00

(52) U.S. Cl. 606/235

(57) ABSTRACT

An article of manufacture for teething infants to bite having a teething device constructed to affix to a mitten, a mitten constructed to fit over an infant's hand, a structure for securing an infant's hand within the mitten, and a way of securing the teething device to the mitten. The teething mitten secures to an infant's hand allowing infant to provide teething relief to him/herself while simultaneously preventing gagging, need for constant parental assistance, and dropping of teething mitten. A preferred embodiment includes the teething device construction to provide a moisture barrier to prevent moisture from penetrating the mitten.

### CROSS REFERENCE TO RELATED APPLICATIONS

This application is based on provisional application Ser. No. 60/558,041, filed on Mar. 31, 2004.

### STATEMENT REGARDING FEDERALLY SPONSORED RESEARCH DEVELOPMENT

Not Applicable

### DESCRIPTION OF ATTACHED APPENDIX

Not Applicable

### TECHNICAL FIELD

The present invention relates to infant care devices and more specifically to infant teethers

### BACKGROUND OF THE INVENTION

Human infants are generally born without teeth. As the infant grows in its first year, teeth begin to grow and break through the gums. The activity of biting helps the infant to relieve the pain suffered while going through the teething process. The teething process generally takes place in the infant's first year when the infant has very little fine motor skills. Infants who are teething will instinctively bite on anything put near their mouth. Often times, their hands are the most accessible items for biting. The constant moisture and biting on the hands can cause redness, tenderness, chaffing, and even bleeding. Infants also tend to gag themselves on their hands as they can reach too far into the mouth. This gagging can result in vomiting which can lead to malnutrition or even death in young infants that may asphyxiate. A teething device, or teether, is a device for an infant to bite on while new teeth are breaking through the gums as the infant grows and can reduce the desire to bite on their hands. Teething devices come in many different shapes, sizes, and materials. Teethers are generally constructed to be appealing to infants by using bright colors, interesting or familiar shapes, and comforting materials for the infant's tender gums and teeth. Semi-soft rubber or a combination of semi-soft rubber and fabric are used most often in the construction of teethers.

The problem with all teethers currently being manufactured is that the younger infant, 2 to 8 months old, generally does not have the fine motor skills to hold and direct a teether to it's mouth. Teething devices are constantly dropped which leaves them soiled, lost, and unused. The only way for a young infant to receive the benefit of a teether is for the parent to hold the teether in the infant's mouth. If the parent does not hold the teether in place, the infant often gravitates to biting the hands which can cause more pain as the hands become raw, and can result in gagging and vomiting.

### BRIEF SUMMARY OF THE INVENTION

The primary object of the invention is to provide a soft teething device for an infant that is easily accessible by being secured to the infant's hand.

Another object of the invention is to provide the means of keeping an infant from gagging themself with their bare hand.

A further object of the invention is to provide a teething device that will not be easily dropped on the unsanitary ground by an infant.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an article of manufacture for teething infants to bite that is secured to an infant's hand comprising: a teething device constructed to affix to a mitten, a mitten comprising a pouch of fabric with opening at bottom, a means of securing a hand in said mitten, and a means of securing said teething device to said mitten.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1. is a view of the invention as separate pieces.

FIG. 2. is a perspective view of the invention in the preferred embodiment.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

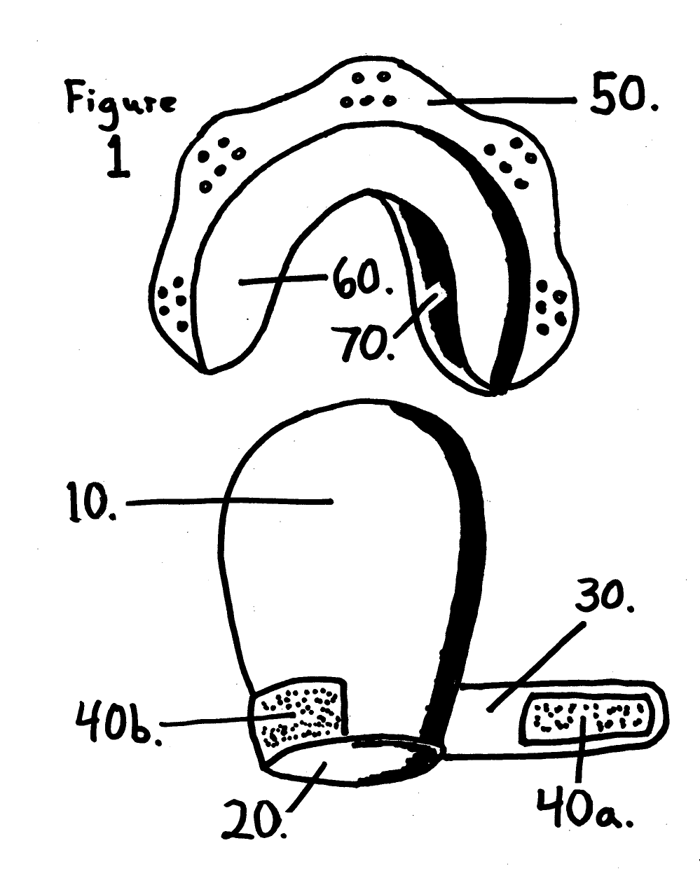

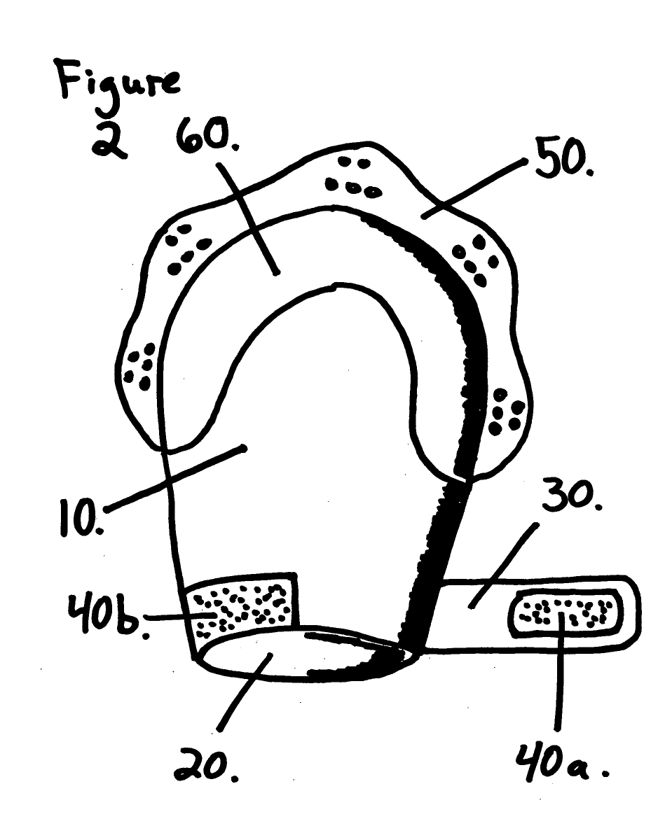

Turning now to the drawings, an exploded view of the article of manufacture can be seen in FIG. 1. and a perspective view can be seen in FIG. 2.

In FIG. 1. the mitten (10.) is a pouch made of soft fabric and is sized such that an infant's hand fits comfortably inside allowing for free range of movement in opening and closing the hand. The opening of the mitten (20.) allows for entry of the hand and in the preferred embodiment is secured to the wrist by a strap (30.) that is lined with Velcro (40a. and 40b.). In Place of the Vecro strap as a means of securing the hand in place, snaps or stretchy material such as elastic may be substituted around the mitten opening. The teething device (50., 60., 70.) is constructed of rubber, silicone, or plastic to provide protrusions (50.) which are soothing to an infant's tender gums. In the illustrated form, the protrusions are bumps, but there may be ridges, swirls, or nothing in place of the bumps in a similar version. The outer biting ring of the teething device (60.) is shown in a pleasing wavy pattern but can be constructed in any shape. The inner area of the teething device (70.) is used both as a moisture barrier preventing saliva from penetrating said mitten and for securing the teether to the mitten through the open area at the bottom (80.). The rounded inner portion forms a cup that fits atop the mitten.

In FIG. 2. the combination teething device and mitten is shown fully constructed with the teething device (50. and 60.) secured to the mitten (10.) using non-toxic adhesive in the preferred embodiment. The teething device can also be secured to the mitten using stitching or Velcro. In use, the mitten (10.) is secured to the infant's hand through the mitten opening (20.) using the strap (30.) lined with Velcro (40a. and 40b). The teething device (50. and 60.) is therefore secured to the top of the infant's hand and is easily available to the infant at any time. The infant can bite and chew on the teether and periodically stop without dropping or losing the teether. The infant can then resume as they desire. The infant has full access to teething pain relief and is prevented from gagging due to the inability to reach their fingers too deeply into their throat. In addition, the infant's hand is protected from becoming red and raw from excess moisture and chewing. The infant is further protected by avoiding an unsanitary condition that can exist when teething devices are dropped and not cleaned properly before reintroducing to the mouth.

The foregoing description of a preferred embodiment of this invention, including any dimensions, angles, or proportions, is intended as illustrative. The concept and scope of the invention are limited only by the following claims and equivalents thereof.

1. An article of manufacture for teething infants to bite comprising:
a teething device constructed to affix to a mitten;
a mitten comprising a pouch of fabric with opening at bottom;
a means of securing a hand in said mitten; and
a means of securing said teething device to said mitten.

2. The apparatus of claim 1, wherein the teething device is constructed of rubber, plastic, or some other pliable material.

3. The apparatus of claim 1, wherein the mitten is constructed of fabric.

4. The apparatus of claim 1, wherein the infant's hand is secured in said mitten by use of a strap lined with Velcro or snaps, or by use of elastic around the opening of said mitten.

5. The apparatus of claim 1, wherein said teething device is secured to said mitten by use of non-toxic glue or stitching.

6. The apparatus of claim 1, wherein said teething device is constructed to provide a means to prevent moisture from penetrating said mitten.

7. A teether, comprising a biting surface; and means for securing biting surface to hand of an infant.
